(19) United States
(12) Patent Application Publication
(10) Pub. No.: US 2020/0128625 A1
(43) Pub. Date: Apr. 23, 2020

(54) HEATER

(71) Applicant: MITSUBISHI HEAVY INDUSTRIES THERMAL SYSTEMS, LTD., Tokyo (JP)

(72) Inventors: Keiji NAGASAKA, Tokyo (JP); Hideo NAKAMURA, Tokyo (JP); Yutaka KUBOTA, Tokyo (JP); Masanori MARUYAMA, Tokyo (JP); Hidetaka SATO, Tokyo (JP); Tomoyasu OSAKI, Tokyo (JP)

(73) Assignee: MITSUBISHI HEAVY INDUSTRIES THERMAL SYSTEMS, LTD., Tokyo (JP)

(21) Appl. No.: 16/066,214

(22) PCT Filed: Mar. 22, 2017
(86) PCT No.: PCT/JP2017/011379

§ 371 Date: Jun. 26, 2018

(30) Foreign Application Priority Data
Mar. 31, 2016 (JP) 2016-073645

(51) Int. Cl. H05B 3/03; H01T 4/10; H01T 4/02; F24H 9/18

(52) U.S. Cl. CPC H05B 3/03; H01T 4/10; H01T 4/02; H05B 2203/021; H05B 2203/016; H05B 2203/02; F24H 9/1818

(57) ABSTRACT

A heater is provided with a heating element that generates heat by electrical connection, anode and cathode plates each formed in a plate shape and are installed such that the heating element is sandwiched between the anode and cathode plates from both sides thereof, and a discharging unit installed in a heating element non-provided region and that discharges a surge current. The heating element non-provided region is included in a facing portion where the anode plate faces the cathode plate and differs from a heating element provided region where the heating element is provided.

### TECHNICAL FIELD

The present invention relates to a heater including a heating element installed between an anode plate and a cathode plate.

Priority is claimed on Japanese Patent Application No. 2016-073645, filed on Mar. 31, 2016, the content of which is incorporated herein by reference.

### BACKGROUND ART

In the related art, a hot water PTC heater is used for heating an electric vehicle (hereinafter, referred to as “EV”) or a plug-in hybrid car (hereinafter, referred to as “PHEV”). In EVs or PHEVs, water is heated by the hot water PTC heater (hereinafter, simply referred to as “heater”) instead of engine waste heat, and heating is carried out by a water pump circulating hot water.

A resistance value significantly changes at a certain temperature in a positive temperature coefficient (PTC) element, which is one type of heating element. For this reason, there is a characteristic in which the temperature of the heating element is almost constant even in a case where a load change or a voltage change occurs. Therefore, even in a case where an unexpected event (such as loss of cooling water) occurs, a possibility that the heating element is overheated is extremely low.

In rare cases, a high surge voltage (for example, a lightning surge) is applied from the outside to the heater having the above configuration.

Patent Document 1 discloses that an element mounted on a circuit substrate is protected by providing a surge suppression circuit on the circuit substrate as a light source lighting device.

### PRIOR ART DOCUMENTS

### Patent Document

Patent Document 1: Japanese Unexamined Patent Application, First Publication No. 2013-145733

### SUMMARY OF INVENTION

### Technical Problem

However, it is difficult to apply the technique disclosed in Patent Document 1 to the heater having the configuration described above since it is necessary to form the surge suppression circuit on the circuit substrate.

If a high surge voltage from the outside is applied to the heater described above, the heating element such as the PTC element may become damaged. In particular, EVs or PHEVs are connected to the outside via a charging cable during charging. Therefore, when a high-voltage surge is applied to the charging cable, a possibility that the heating element such as the PTC element becomes damaged is high.

An object of the present invention is to provide a heater that can suppress damage to a heating element by discharging a surge current generated when a surge voltage is applied.

### Solution to Problem

According to a first aspect of the present invention, a heater is provided with: a heating element configured to generate heat by electrical connection; an anode plate and a cathode plate each formed in a plate shape and are installed such that the heating element is sandwiched between the anode and cathode plates from both sides thereof; and a discharging unit that is installed in a heating element non-provided region, which is included in a facing portion where the anode plate faces the cathode plate and differs from a heating element provided region where the heating element is provided, and configured to discharge a surge current.

According to the present invention, a surge current can be consumed by the discharging unit discharging the surge current flowing when a high surge voltage is applied from the outside. Accordingly, damage to the heating element attributable to a surge current can be suppressed.

In the heater according to one aspect of the present invention, it may be such that: the anode plate has a first surface corresponding to the heating element non-provided region and facing the cathode plate; the anode plate has a second surface corresponding to the heating element non-provided region and facing the anode plate; the discharging unit includes a first discharging unit provided with a first protruding portion installed on the first surface and protrudes in a direction toward the second surface, and a second protruding portion installed on the second surface and protrudes in a direction toward the first surface; and a tip of the first protruding portion faces a tip of the second protruding portion so as to be spaced at a predetermined interval therebetween.

As described above, the heater has the first discharging unit including the first and second protruding portions. A surge current intends to flow between the first and second protruding portions of which the tips are spaced at a distance shorter than an interval between the anode plate and the cathode plate. Consequently, the surge current can be discharged between the tip of the first protruding portion and the tip of the second protruding portion. Accordingly, damage to the heating element attributable to a surge current can be suppressed.

In the heater according to one aspect of the present invention, the heater may be further provided with a metal housing in which the heating element, the anode plate, and the cathode plate are accommodated, wherein the discharging unit may include a second discharging unit installed at a portion where the metal housing faces the anode plate, and the second discharging unit has a third protruding portion installed on the metal housing and a fourth protruding portion installed on the anode plate such that a tip of the fourth protruding portion faces a tip of the third protruding portion so as to be spaced at a predetermined interval therebetween.

Since the heater has the second discharging unit configured in such a manner, a surge current flowing from the metal housing to the anode plate can be discharged by the second discharging unit.

In the heater according to one aspect of the present invention, it may be such that: the discharging unit includes a third discharging unit installed at a portion where the metal housing faces the cathode plate; and the third discharging unit has a fifth protruding portion installed on the metal housing and a sixth protruding portion provided on the anode plate such that a tip of the sixth protruding portion faces a tip of the fifth protruding portion so as to be spaced at a predetermined interval therebetween.

Since the heater has the third discharging unit configured in such a manner, a surge current flowing from the metal housing to the cathode plate can be discharged by the third discharging unit.

In the heater according to one aspect of the present invention, it may be such that: the anode plate has a first surface corresponding to the heating element non-provided region and facing the cathode plate; the anode plate has a second surface corresponding to the heating element non-provided region and facing the anode plate; and the discharging unit includes a first insulating member of which a withstand voltage lower than that of the heating element and which is in contact with the first and second surfaces.

As described above, since the heater has the discharging unit including the first insulating member that is provided to be in contact with the first and second surfaces and has a withstand voltage lower than that of the heating element, a surge current can be led to the first insulating member so as to be consumed by the first insulating member. Therefore, damage to the heating element attributable to the surge current can be suppressed.

In the heater according to one aspect of the present invention, it may be such that the discharging unit includes a second insulating member of which a withstand voltage higher than that of the heating element and which is in contact with the first and second surfaces, wherein the second insulating member is installed to cover a periphery of the first insulating member.

Since the discharging unit has the second insulating member configured in such a manner, a surge current can be led to the first insulating member. Then, an interval between the anode plate and the cathode plate for a portion where the first insulating member is provided can be kept at a desired interval. That is, since the second insulating member functions as a spacer, the thickness of the first insulating member can be kept constant.

In the heater according to one aspect of the present invention, the heater may be further provided with a metal housing in which the heating element, the anode plate, and the cathode plate are accommodated, wherein the discharging unit may be installed to be in contact with the anode plate, the cathode plate, and the metal housing at a portion where the anode plate faces the metal housing and a portion where the cathode plate faces the metal housing.

As described above, since the discharging unit including the first insulating member is provided at the location described above, a surge current can be discharged at the portion where the anode faces the metal housing and the portion where the cathode faces the metal housing.

In the heater according to one aspect of the present invention, the heater may be further provided with a metal housing in which the heating element, the anode plate, and the cathode plate are accommodated and which includes a cover portion, and wherein the first insulating member may be installed at an end of one of the anode plate and the cathode plate, which is positioned close to the cover portion of the metal housing, and a portion of the cover portion, which faces the end of the electrode plate, may be provided with an inspection window.

In such a manner described above, soot (phenomenon of having soot and being blackened) generated when a surge current is discharged by the discharging unit can be checked via the inspection window. Accordingly, a user can check the location where a surge current is discharged.

In the heater according to one aspect of the present invention, it may be such that: the anode plate has a first surface corresponding to the heating element non-provided region and facing the cathode plate; the anode plate has a second surface corresponding to the heating element non-provided region and facing the anode plate; the discharging unit includes a first protruding portion formed on the first surface, a second protruding portion formed on the second surface so as to face the first protruding portion, wherein the first protruding portion and the second protruding portion are spaced at a predetermined interval therebetween, and a third insulating member formed between the first surface and the second surface so as to be in contact with the first surface, the second surface, the first protruding portion, and the second protruding portion, wherein a withstand voltage of the third insulating member is set to be lower than that of the heating element; and the first and second protruding portions are buried under the third insulating member.

Since such configuration elements are included, the thickness of a portion of the third insulating member having a withstand voltage lower than that of the heating element, which is installed between the first and second protruding portions, can be made smaller. Accordingly, a surge current can be discharged at this portion since the surge current intends to flow in the third insulating member installed between the first and second protruding portions. That is, damage to the heating element attributable to a surge current can be suppressed.

In the heater according to one aspect of the present invention, it may be such that: the anode plate has an anode plate body and a first terminal unit extending from the anode plate body; the cathode plate has a cathode plate body and a second terminal unit extending from the cathode plate body; and the discharging unit is provided in the heating element non-provided region formed between the first terminal unit and the second terminal unit.

Since the discharging unit is provided at such a position, a surge current can be discharged in front of the heating element when the surge current flows in the first and second terminals.

### Advantageous Effects of Invention

According to the present invention, damage to the heating element attributable to a surge current can be suppressed by discharging the surge current generated when a surge voltage is applied.

### BRIEF DESCRIPTION OF DRAWINGS

FIG. 1 is a perspective view illustrating an appearance of a heater according to a first embodiment of the present invention.

FIG. 2 is a sectional view when the heater illustrated in FIG. 1 is cut along A1-A2 line.

FIG. 3 is a plan view of an anode plate illustrated in FIG. 2.

FIG. 4 is a plan view of a cathode plate illustrated in FIG. 2.

FIG. 5 is a sectional view illustrating a heater according to a first modification example of the first embodiment of the present invention.

FIG. 6 is a view schematically illustrating configurations of main portions of a heater according to a second modification example of the first embodiment of the present invention.

FIG. 7 is a sectional view illustrating a heater according to a second embodiment of the present invention.

FIG. 8 is a view of a heater body, which is illustrated in FIG. 7, in plan view.

FIG. 9 is a sectional view when the heater body and a part of a housing, which are illustrated in FIG. 7, are cut along B1-B2 line.

FIG. 10 is a sectional view illustrating main portions of a heater according to a third embodiment of the present invention.

FIG. 11 is a sectional view illustrating main portions of a heater according to a fourth embodiment of the present invention.

### DESCRIPTION OF EMBODIMENTS

Hereinafter, embodiments to which the present invention is applied will be described in detail with reference to the drawings. The drawings which will be referred to in the following description are merely for describing configurations of the embodiments of the present invention, and the size, thickness, or dimension of each of illustrated portions is different from a dimensional relationship of an actual rotary machine in some cases.

### First Embodiment

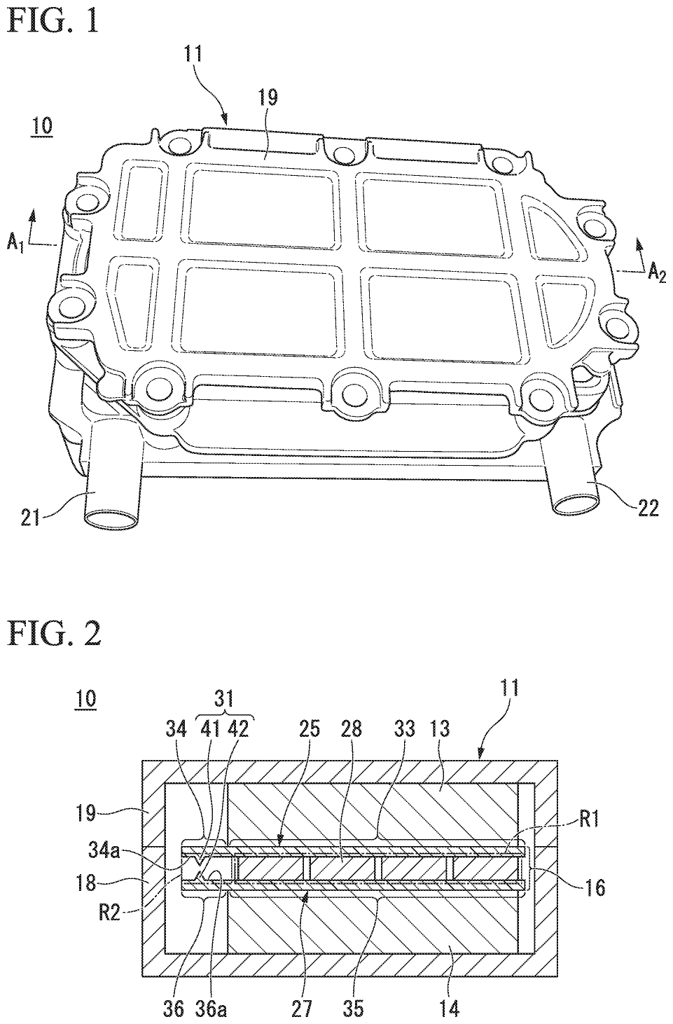

FIG. 1 is a perspective view illustrating an appearance of a heater according to a first embodiment of the present invention. FIG. 2 is a sectional view when the heater illustrated in FIG. 1 is cut along A1-A2 line. In FIG. 2, the same configuration portions as those of the structure illustrated in FIG. 1 will be assigned with the same reference signs.

Referring to FIGS. 1 and 2, a heater 10 of the first embodiment has a metal housing 11, a first hot water flow path member 13, a second hot water flow path member 14, and a heater body 16.

The metal housing 11 is an earth, and has a housing body 18, a cover portion 19, a hot water introduction portion 21, and a hot water leading-out portion 22.

The housing body 18 accommodates the second hot water flow path member 14 and the heater body 16. The cover portion 19 is configured to be detachable with respect to the housing body 18.

The hot water introduction portion 21 is provided in the housing body 18. The hot water introduction portion 21 is a portion for introducing hot water to the first hot water flow path member 13.

The hot water leading-out portion 22 is provided in the housing body 18. The hot water leading-out portion 22 is a portion for leading hot water out from the second hot water flow path member 14.

The first hot water flow path member 13 has a first flow path in which hot water flows. The hot water flowing in the first flow path is heated by the heater body 16. The hot water that has passed through the inside of the first hot water flow path member 13 is introduced to the second hot water flow path member 14.

The second hot water flow path member 14 has a second flow path in which hot water introduced from the first hot water flow path member 13 flows. The hot water flowing in the second flow path is heated by the heater body 16. The hot water that has passed through the inside of the second hot water flow path member 14 is led out to the outside of the heater 10.

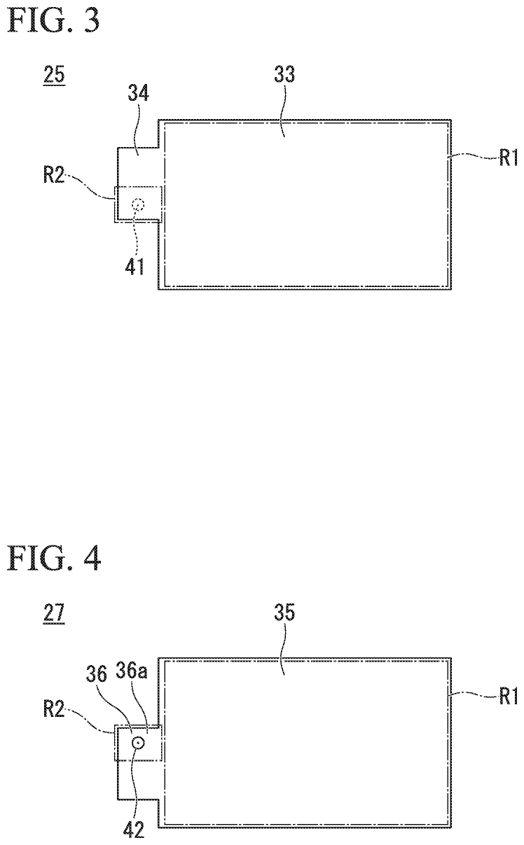

FIG. 3 is a plan view of an anode plate illustrated in FIG. 2. FIG. 4 is a plan view of a cathode plate illustrated in FIG. 2. FIGS. 3 and 4 are views schematically illustrating an anode plate 25 and a cathode plate 27 in plan view from an upper side of the structures illustrated in FIG. 2. In addition, in FIGS. 3 and 4, a heating element provided region R1 and a heating element non-provided region R2 are illustrated such that a positional relationship among the anode plate 25, the cathode plate 27, the heating element provided region R1, and the heating element non-provided region R2 could be understood. In FIGS. 3 and 4, the same configuration portions as those of the structure illustrated in FIG. 2 will be assigned with the same reference signs.

Referring to FIGS. 2 to 4, the heater body 16 is installed between the first hot water flow path member 13 and the second hot water flow path member 14.

The heater body 16 has the anode plate 25, the cathode plate 27, the heating element provided region R1, the heating element non-provided region R2, heating elements 28, and a first discharging unit 31, which is a discharging unit.

The anode plate 25 is installed on a first hot water flow path member 13 side, and includes an anode plate body 33 and a first terminal unit 34.

The anode plate body 33 is a rectangular member configured to have a larger appearance than the first terminal unit 34.

The first terminal unit 34 is provided to extend from one side of the anode plate body 33. A part (portion that defines the heating element non-provided region R2 illustrated in FIG. 3) of the first terminal unit 34 faces a part (portion that defines the heating element non-provided region R2 illustrated in FIG. 4) of a second terminal unit 36 to be described later.

A part of the first terminal unit 34 has a first surface 34a corresponding to the heating element non-provided region R2 and facing the second terminal unit 36. The first terminal unit 34 is a portion connected to a cable.

The cathode plate 27 is installed on a second hot water flow path member 14 side, and includes a cathode plate body 35 and the second terminal unit 36.

The cathode plate body 35 is a rectangular member configured to have a larger appearance than the second terminal unit 36.

The second terminal unit 36 is provided to extend from one side of the cathode plate body 35. A part of the second terminal unit 36 has a second surface 36a corresponding to the heating element non-provided region R2 and facing the first terminal unit 34. The second terminal unit 36 is a portion connected to a cable.

The first terminal unit 34 and the second terminal unit 36 described above are configured such that a part (portions that define the heating element non-provided region R2 illustrated in FIGS. 3 and 4) of each unit overlaps each other in a direction of the height of the metal housing 11.

The heating element provided region R1 is a region between the anode plate body 33 and the cathode plate body 35, and is defined by the anode plate body 33 and the cathode plate body 35. The heating element provided region R1 is a region where the plurality of heating elements 28 are provided.

The heating element non-provided region R2 is a region defined by the first terminal unit 34 facing the second terminal unit 36. The heating element non-provided region R2 is a region where the heating elements 28 are not formed.

The plurality of heating elements 28 are installed in the heating element provided region R1 defined between the anode plate 25 and the cathode plate 27. The plurality of heating elements 28 are installed at predetermined intervals in a longitudinal direction of the anode plate 25 and the cathode plate 27. A PTC element or a heat-generating body by resistance can be given as an example of the heating elements 28.

The first discharging unit 31 has a first protruding portion 41 and a second protruding portion 42. The first protruding portion 41 is provided on the first surface 34a, and protrudes in a direction toward the second surface 36a. The first protruding portion 41 is configured of a metal material. The first protruding portion 41 is integrated, for example, with the anode plate 25. In this case, the first protruding portion 41 can be formed collectively when manufacturing the anode plate 25.

The second protruding portion 42 is provided on the second surface 36a, and protrudes in a direction toward the first surface 34a. The tip of the first protruding portion 41 and the tip of the second protruding portion 42 are installed to face each other at a predetermined interval. The predetermined interval can be set, for example, within a range of 0.1 mm to 0.2 mm as appropriate.

The second protruding portion 42 is configured of a metal material. The second protruding portion 42 is integrated, for example, with the cathode plate 27. In this case, the second protruding portion 42 can be formed collectively when manufacturing the cathode plate 27.

The heater 10 of the first embodiment has the first discharging unit 31 including the first and second protruding portions 41 and 42 described above. Therefore, a surge current intends to flow between the first and second protruding portions 41 and 42 of which the tips are spaced at a distance shorter than an interval between the anode plate 25 and the cathode plate 27. Consequently, a surge current can be discharged between the tip of the first protruding portion 41 and the tip of the second protruding portion 42. Accordingly, damage to the heating elements 28 attributable to a surge current can be suppressed.

In addition, by disposing the first discharging unit 31 between the first and second terminal units 34 and 36, which are connected to cables, a surge current can be discharged in front of the plurality of heating elements 28.

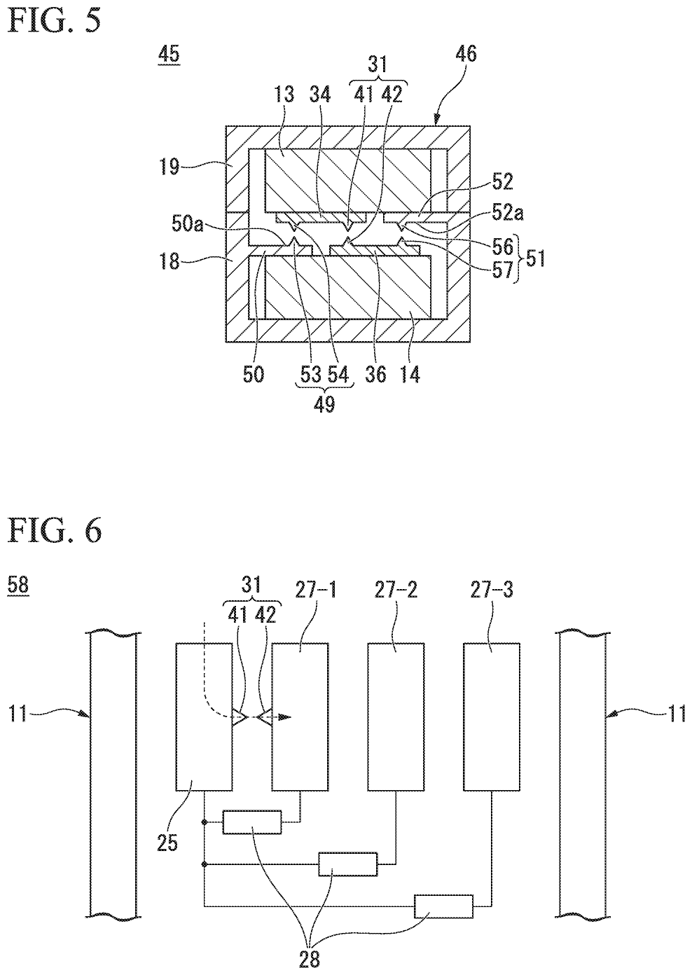

FIG. 5 is a sectional view illustrating a heater according to a modification example of the first embodiment of the present invention. In FIG. 5, the same configuration portions as those of the structures illustrated in FIGS. 1 to 4 will be assigned with the same reference signs.

Referring to FIG. 5, a heater 45 according to the modification example of the first embodiment has a metal housing 46 instead of the metal housing 11 as the first embodiment, and is configured the same as the heater 10 except that the heater 45 further includes a second discharging unit 49 and a third discharging unit 51.

The metal housing 46 is configured the same as the metal housing 11 except that the metal housing 46 has a first extending portion 50 and a second extending portion 52.

The first extending portion 50 extends from an inner wall of the housing body 18, which is positioned below the first terminal unit 34, so as to face the first terminal unit 34. The first extending portion 50 has a surface 50a facing the first terminal unit 34.

The second extending portion 52 extends from an inner wall of the housing body 18, which is positioned above the second terminal unit 36, to face the second terminal unit 36. The second extending portion 52 has a surface 52a facing the second terminal unit 36.

The second discharging unit 49 has a third protruding portion 53 provided on the first extending portion 50 and a fourth protruding portion 54 provided on the first terminal unit 34 such that the tip of the fourth protruding portion faces the tip of the third protruding portion 53 so as to be spaced at a predetermined interval therebetween.

The third and fourth protruding portions 53 and 54 are configured of a metal material. The third protruding portion 53 is configured to be integrated with the first extending portion 50. The fourth protruding portion 54 is configured to be integrated with the first terminal unit 34.

The third discharging unit 51 may have a fifth protruding portion 56 provided on the second extending portion 52 and a sixth protruding portion 57 provided on the second terminal unit 36 such that the tip of the sixth protruding portion faces the tip of the fifth protruding portion 56 so as to be spaced at a predetermined interval therebetween.

The fifth and sixth protruding portions 56 and 57 are configured of a metal material. The fifth protruding portion 56 is configured to be integrated with the second extending portion 52. The fifth protruding portion 56 is configured to be integrated with the second terminal unit 36.

Since the heater 45 of a first modification example of the first embodiment has the second discharging unit 49 described above, a surge current flowing from the metal housing 46 to the anode plate can be discharged by the second discharging unit 49. In addition, since the heater has the third discharging unit 51 described above, a surge current flowing from the metal housing 46 to the cathode plate can be discharged by the third discharging unit 51.

FIG. 6 is a view schematically illustrating configurations of main portions of a heater according to a second modification example of the first embodiment of the present invention. In FIG. 6, the same configuration portions as those of the structures illustrated in FIGS. 1 to 4 will be assigned with the same reference signs.

Referring to FIG. 6, a heater 58 of the second modification example of the first embodiment is configured the same as the heater 10 of the first embodiment except that a plurality of cathode plates 27-1 to 27-3 are positioned to face one anode plate 25 and each of the heating elements 28 is positioned between the anode plate 25 and the cathode plates 27-1 to 27-3.

In the heater 58 of the second modification example of the first embodiment, damage to the plurality of heating elements 28 attributable to the surge current can be suppressed since a surge current flows in a direction illustrated with a dotted arrow in FIG. 6 and the surge current is discharged by the first discharging unit 31.

### Second Embodiment

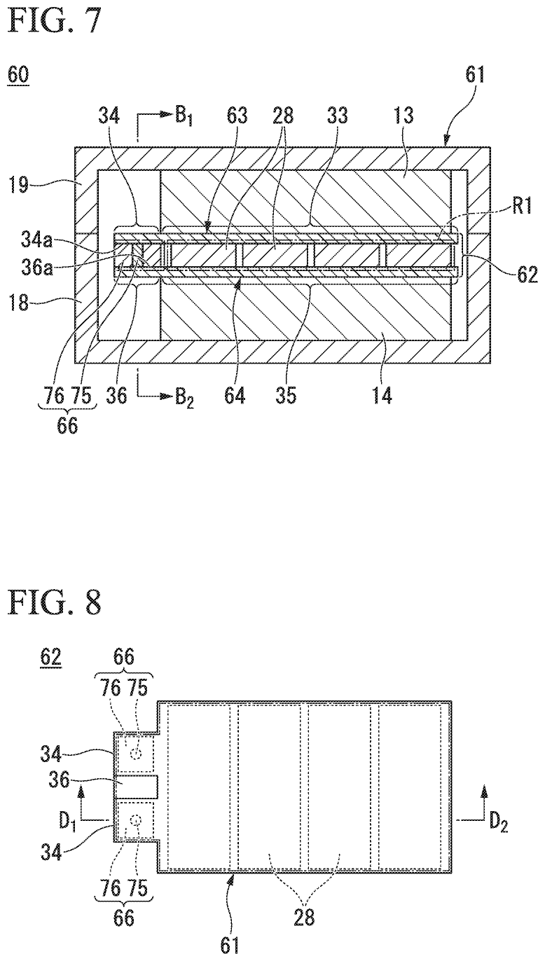

FIG. 7 is a sectional view illustrating a heater according to a second embodiment of the present invention. A cut position of a structure illustrated in FIG. 7 corresponds to a cut position of D1-D2 line illustrated in FIG. 8. In FIG. 7, the same configuration portions as those of the structures illustrated in FIGS. 1 to 4 will be assigned with the same reference signs.

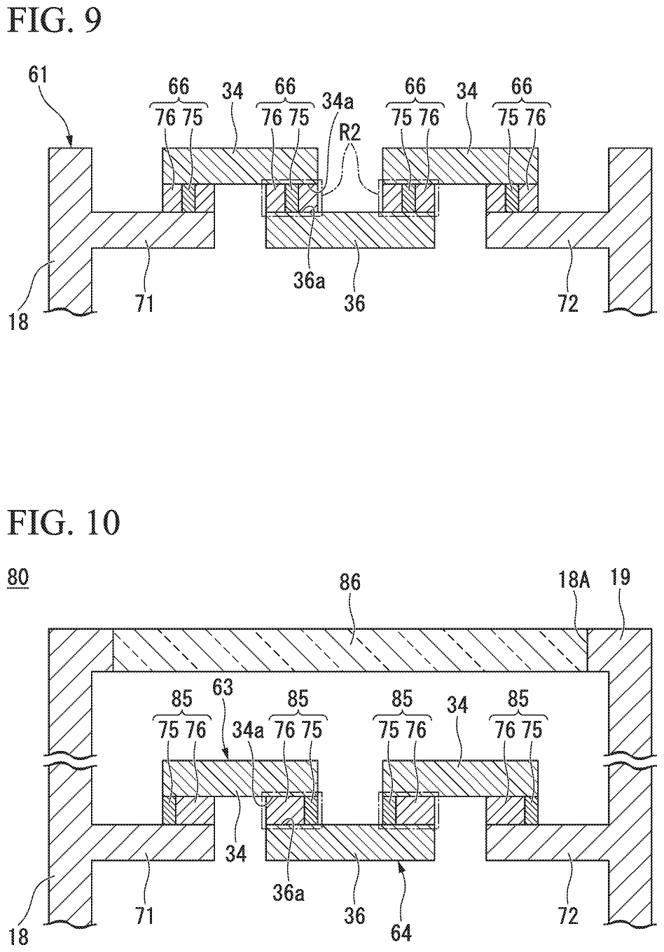

FIG. 8 is a view of the heater body, which is illustrated in FIG. 7, in plan view. In FIG. 8, the same configuration portions as those of the structure illustrated in FIG. 7 will be assigned with the same reference signs. FIG. 9 is a sectional view when the heater body and a part of the housing, which are illustrated in FIG. 7, are cut along B1-B2 line. In FIG. 9, the same configuration portions as those of the structures illustrated in FIGS. 7 and 8 will be assigned with the same reference signs.

Referring to FIGS. 7 to 9, a heater 60 according to the second embodiment is configured the same as the heater 10 except that the heater 60 has a metal housing 61, a heater body 62, and discharging units 66 instead of the metal housing 11, the heater body 16, and the first discharging unit 31, which configure the heater 10 of the first embodiment.

The metal housing 61 is configured the same as the metal housing 11 except that the metal housing 61 has a first extending portion 71 and a second extending portion 72.

The first extending portion 71 extends in a direction toward the second terminal unit 36 to face a part of one first terminal unit 34, from one inner wall of the housing body 18, which is positioned below this first terminal unit 34.

The second extending portion 72 extends in a direction toward the second terminal unit 36 to face a part of the other first terminal unit 34, from the other inner wall of the housing body 18, which is positioned below this first terminal unit 34. The upper surfaces of the first and second extending portions 71 and 72 are disposed to be at the same height as the second surface 36a.

The heater body 62 is configured the same as the heater body 16 except that the heater body 62 has an anode plate body 63 and a cathode plate body 64 instead of the anode plate body 33 and the cathode plate body 35, which configure the heater body 16 described in the first embodiment.

The anode plate body 63 is different from the anode plate body 33 in that two first terminal units 34 are included.

The cathode plate body 64 is configured the same as the cathode plate body 35 except that one second terminal unit 36 is positioned to face a part of each of the two first terminal units 34. Accordingly, the heater body 62 has two heating element non-provided regions R2.

The discharging units 66 each have a first insulating member 75 and a second insulating member 76. The first insulating members 75 are each members having a withstand voltage lower than those of the heating elements 28. The first insulating members 75 are each provided in a middle portion of each of the heating element non-provided regions R2 so as to be in contact with the first and second surfaces 34a and 36a. The shape of each of the first insulating members 75 can be set to, for example, a cylindrical shape.

Since the first insulating members 75 configured in such a manner are included, a surge current can be led to the first insulating members 75 so as to be consumed by the first insulating members 75. Therefore, damage to the heating elements 28 attributable to the surge current can be suppressed.

The second insulating members 76 are each members having a withstand voltage higher than those of the heating elements 28. The second insulating members 76 are each provided to be in contact with the first and second surfaces 34a and 36a and to cover the periphery of each of the first insulating member 75. For example, insulating sheets can be used as the second insulating members 76.

Since the second insulating members 76 configured in such a manner are included, a surge current can be led to the first insulating members 75. Then, an interval between the first terminal units 34 and the second terminal unit 36 for portions where the first insulating members 75 are provided can be kept at a desired interval. That is, since the second insulating members 76 function as spacers, the thickness of each of the first insulating members 75 can be kept constant.

In a case where the withstand voltage of each of the heating elements 28 is 25 kV/mm, for example, a polyethylene-based resin having a withstand voltage of approximately 20 kV/mm can be used as the first insulating members 75. In this case, for example, a polycarbonate-based resin having a withstand voltage of approximately 30 kV/mm can be used as the second insulating members 76.

The discharging units 66 are also provided between the first terminal units 34 and the first and second extending portions 71 and 72. The same effects as the second and third discharging units 49 and 51 described before can be obtained by providing the discharging units 66 also between the first terminal units 34 and the first and second extending portions 71 and 72 as described above.

Since the heater 60 of the second embodiment has the discharging units 66 including the first and second insulating members 75 and 76, the same effects as the heater 10 of the first embodiment can be obtained.

Although a case where the second insulating members 76 are included as configuration elements of the discharging units 66 is given an example in the second embodiment, the second insulating members 76 are not required configurations and may be provided as necessary.

### Third Embodiment

FIG. 10 is a sectional view illustrating main portions of a heater according to a third embodiment of the present invention. In FIG. 10, the same configuration portions as those of the structures illustrated in FIGS. 7 to 9 will be assigned with the same reference signs.

Referring to FIG. 10, a heater 80 according to the third embodiment is configured the same as the heater 60 except that discharging units 85 are provided instead of the discharging units 66 as the heater 60 of the second embodiment and an inspection window 86 is installed in an opening portion 18A provided in the housing body 18.

The discharging units 85 are configured the same as the discharging units 66 except that positions where the first insulating members 75 are provided are different from the discharging units 66 of the second embodiment.

The first insulating members 75 as the discharging units 85 are installed at ends of an electrode plate put on a cover portion 19 side of the housing (in the case of FIG. 10, the anode plate body 63), out of the anode plate body 63 and the cathode plate body 64.

Accordingly, when any one of the plurality of discharging units 85 has discharged a surge current, soot (phenomenon of having soot and being blackened) is generated on an upper surface of any one of the second terminal unit 36, the first extending portion 71, and the second extending portion 72.

The opening portion 18A is provided in a portion of the housing body 18, which faces the end of the anode plate body 63 where the soot can be found. The inspection window 86 is provided in the opening portion 18A. For example, glass can be used as a material of the inspection window 86.

Even in the case of the second embodiment described before, soot is generated on the periphery of each of the first insulating members 75 when a surge current is discharged. However, in the case of the second embodiment, the periphery of each of the first insulating members 75 is covered with each of the second insulating members 76, and the first insulating members are also covered with the first terminal units 34 and the second terminal unit 36 in an up-and-down direction. For this reason, in the case of the second embodiment, determination as to whether or not a surge current is discharged cannot be made if the first and second terminal units 34 and 36 are not disassembled.

On the other hand, in the heater 80 of the third embodiment, an operator can easily check soot (phenomenon of having soot and being blackened), which is generated when a surge current is discharged, from the outside via the inspection window 86, since a part of the periphery of each of the first insulating members 75 is exposed from each of the second insulating members 76, and the first and second terminal units 34 and 36 are installed at positions where soot can be checked without obstruction.

### Fourth Embodiment

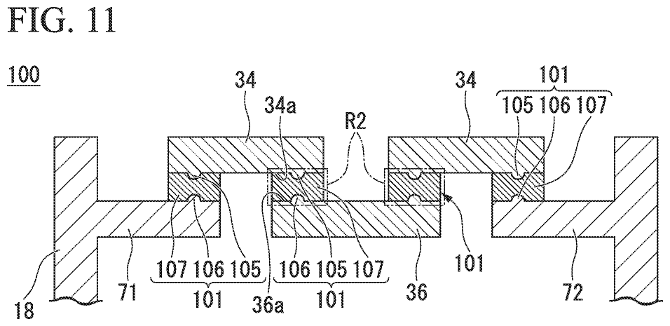

FIG. 11 is a sectional view illustrating main portions of a heater according to a fourth embodiment of the present invention. In FIG. 11, the same configuration portions as those of the structure illustrated in FIG. 9 will be assigned with the same reference signs.

Referring to FIG. 11, a heater 100 according to the fourth embodiment is configured the same as the heater 60 except that the heater 100 has discharging units 101 instead of the discharging units 66 as the heater 60 of the second embodiment.

The discharging units 101 each have a first protruding portion 105, a second protruding portion 106, and a third insulating member 107.

The first protruding portions 105 are each provided on the first surface 34a, and protrude downwards. The second protruding portions 106 are each provided on the second surface 36a to face the first protruding portion 105. The second protruding portions 106 protrude upwards. The second protruding portions 106 and the first protruding portions 105 have predetermined intervals therebetween. The first and second protruding portions 105 and 106 are configured of a metal material.

The third insulating members 107 are each provided between the first surface 34a and the second surface 36a so as to be in contact with the first and second surfaces 34a and 36a and the first and second protruding portions 105 and 106. The third insulating members 107 are each members having a withstand voltage lower than those of the heating elements.

The first and second protruding portions 105 and 106 are buried under the third insulating members 107. The third insulating members 107 can be configured of the same material of the first insulating members 75 described before.

In the heater 100 of the fourth embodiment, the thickness of a portion of each of the third insulating members 107 having a withstand voltage lower than those of the heating elements, which is installed between the first and second protruding portions 105 and 106, can be made smaller. Accordingly, a surge current can be discharged at this portion since the surge current intends to flow in the third insulating members 107 installed between the first and second protruding portions 105 and 106. Therefore, damage to the heating elements attributable to a surge current can be suppressed.

Although the preferable embodiments of the present invention are described in detail hereinbefore, the present invention is not limited to particular embodiments, and various modifications and changes can be made thereto without departing from the spirit of the present invention described in Claims.

For example, the first discharging unit 31, the second discharging unit 49, the third discharging unit 51, and the discharging units 66, 85, and 101, which are described in the first to fourth embodiments, may be combined.

In addition, although a case where the first discharging unit 31 and the discharging units 66, 85, and 101 are provided between the first terminal unit 34 and the second terminal unit 36 is given as an example in the first to fourth embodiments, it is sufficient that positions where the first discharging unit 31 and the discharging units 66, 85, and 101 are provided in a region where the heating elements 28 are not formed, and the positions are not limited to positions described in the first to fourth embodiments.

### INDUSTRIAL APPLICABILITY

The present invention is applicable to a heater including a heating element installed between an anode plate and a cathode plate.

### REFERENCE SIGNS LIST

10, 45, 58, 60, 80, 100 heater

11, 46, 61 metal housing

13 first hot water flow path member

14 second hot water flow path member

16, 62 heater body

18 housing body

18A opening portion

19 cover portion

21 hot water introduction portion

22 hot water leading-out portion

25 anode plate

27, 27-1 to 27-3 cathode plate

28 heating element

31 first discharging unit

33, 63 anode plate body

34 first terminal unit

34a first surface

35, 64 cathode plate body

36 second terminal unit

36a second surface

41 first protruding portion

42 second protruding portion

49 second discharging unit

50, 71 first extending portion

50a, 52a surface

51 third discharging unit

52, 72 second extending portion

53 third protruding portion

54 fourth protruding portion

56 fifth protruding portion

57 sixth protruding portion

66, 85, 101 discharging unit

75 first insulating member

76 second insulating member

86 inspection window

105 first protruding portion

106 second protruding portion

107 third insulating member

R1 heating element provided region

R2 heating element non-provided region

1-10. (canceled)

11. A heater, comprising:
a heating element configured to generate heat by electrical connection;
an anode plate and a cathode plate each formed in a plate shape and are installed such that the heating element is sandwiched between the anode and cathode plates from both sides thereof;
a discharging unit that is installed in a heating element non-provided region, which is included in a facing portion where the anode plate faces the cathode plate and differs from a heating element provided region where the heating element is provided, and configured to discharge a surge current, and
a metal housing in which the heating element, the anode plate, and the cathode plate are accommodated, wherein
the discharging unit includes a second discharging unit installed at a portion where the metal housing faces the anode plate, and
the second discharging unit has a third protruding portion installed on the metal housing and a fourth protruding portion installed on the anode plate such that a tip of the fourth protruding portion faces a tip of the third protruding portion so as to be spaced at a predetermined interval therebetween.

12. The heater according to claim 11, wherein
the anode plate has a first surface corresponding to the heating element non-provided region and facing the cathode plate,
the cathode plate has a second surface corresponding to the heating element non-provided region and facing the anode plate,
the discharging unit includes a first discharging unit provided with a first protruding portion installed on the first surface and protrudes in a direction toward the second surface, and a second protruding portion installed on the second surface and protrudes in a direction toward the first surface, and
a tip of the first protruding portion faces a tip of the second protruding portion so as to be spaced at a predetermined interval therebetween.

13. The heater according to claim 11, wherein
the discharging unit includes a third discharging unit installed at a portion where the metal housing faces the cathode plate, and
the third discharging unit has a fifth protruding portion installed on the metal housing and a sixth protruding portion provided on the anode plate such that a tip of the sixth protruding portion faces a tip of the fifth protruding portion so as to be spaced at a predetermined interval therebetween.

14. The heater according to claim 11, wherein
the anode plate has a first surface corresponding to the heating element non-provided region and facing the cathode plate,
the cathode plate has a second surface corresponding to the heating element non-provided region and facing the anode plate, and
the discharging unit includes a first insulating member of which a withstand voltage lower than that of the heating element and which is in contact with the first and second surfaces.

15. The heater according to claim 14, wherein
the discharging unit includes a second insulating member of which a withstand voltage higher than that of the heating element and which is in contact with the first and second surfaces, wherein the second insulating member is installed to cover a periphery of the first insulating member.

16. The heater according to claim 11, further comprising a metal housing in which the heating element, the anode plate, and the cathode plate are accommodated, wherein
the discharging unit is installed to be in contact with the anode plate, the cathode plate, and the metal housing at a portion where the anode plate faces the metal housing and a portion where the cathode plate faces the metal housing.

17. The heater according to claim 14, further comprising a metal housing in which the heating element, the anode plate, and the cathode plate are accommodated and which includes a cover portion, wherein
the first insulating member is installed at an end of one of the anode plate and the cathode plate, which is positioned close to the cover portion of the metal housing, and
a portion of the cover portion, which faces the end of the electrode plate, is provided with an inspection window.

18. The heater according to claim 11, wherein
the anode plate has a first surface corresponding to the heating element non-provided region and facing the cathode plate,
the cathode plate has a second surface corresponding to the heating element non-provided region and facing the anode plate,
the discharging unit includes
a first protruding portion formed on the first surface,
a second protruding portion formed on the second surface so as to face the first protruding portion, wherein the first protruding portion and the second protruding portion are spaced at a predetermined interval therebetween, and
a third insulating member formed between the first surface and the second surface so as to be in contact with the first surface, the second surface, the first protruding portion, and the second protruding portion, wherein a withstand voltage of the third insulating member is set to be lower than that of the heating element, and
the first and second protruding portions are buried under the third insulating member.

19. The heater according to claim 11, wherein
the anode plate has an anode plate body and a first terminal unit extending from the anode plate body,
the cathode plate has a cathode plate body and a second terminal unit extending from the cathode plate body, and
the discharging unit is provided in the heating element non-provided region formed between the first terminal unit and the second terminal unit.
